(19) United States
(12) Patent Application Publication
(10) Pub. No.: US 2024/0127710 A1
(43) Pub. Date: Apr. 18, 2024

(54) SYSTEM AND METHOD FOR AUTOMATICALLY EVALUATING ESSAY FOR WRITING LEARNING

(71) Applicant: ELECTRONICS AND TELECOMMUNICATIONS RESEARCH INSTITUTE, Daejeon (KR)

(72) Inventors: Minsoo CHO, Daejeon (KR); Oh Woog KWON, Daejeon (KR); Yoon-Hyung ROH, Daejeon (KR); Ki Young LEE, Daejeon (KR); Yo Han LEE, Daejeon (KR); Sung Kwon CHOI, Daejeon (KR); Jinxia HUANG, Daejeon (KR)

(73) Assignee: ELECTRONICS AND TELECOMMUNICATIONS RESEARCH INSTITUTE, Daejeon (KR)

(21) Appl. No.: 18/302,637

(22) Filed: Apr. 18, 2023

(30) Foreign Application Priority Data
Oct. 17, 2022 (KR) 10-2022-0133133

(51) Int. Cl. G09B 19/00; G06F 40/232; G06F 40/253; G06F 40/284

(52) U.S. Cl. CPC G09B 19/00; G06F 40/232; G06F 40/253; G06F 40/284

(57) ABSTRACT

Disclosed are a system and method for automatically evaluating an essay. The system includes a structure analysis module configured to divide learning data and learner essay text in a predetermined structure analysis unit, generate structure tagging information for each structure analysis unit, and structure the learning data and the learner essay text by attaching the structure tagging information to the learning data and the learner essay text, a learning module configured to generate an essay evaluation model through learning by using essay text that is included in the structured learning data and the structure tagging information as an input value and using an evaluation score that is included in the structured learning data as a label, and an evaluation module configured to generate essay evaluation results using the essay evaluation model.

### CROSS-REFERENCE TO RELATED APPLICATION

This application claims priority to and the benefit of Korean Patent Application No. 10-2022-0133133, filed on Oct. 17, 2022, the disclosure of which is incorporated herein by reference in its entirety.

### BACKGROUND

### 1. Technical Field

The present disclosure relates to a system and method for automatically evaluating an essay, which provide feedback by synthetically evaluating an essay of a writing learner.

### 2. Related Art

A system for automatically evaluating an essay is recently used as a scoring tool for writing education instead of a professional evaluator because the system can evaluate an essay of a writing learner rapidly and conveniently. However, the existing system for automatically evaluating an essay merely provides a holistic score or level for the entire essay, rather than providing feedback in which even a structural aspect has been considered like an actual evaluator. In order to process more various types of essay in one system structure and provide a learner with feedback suitable for an essay structure, evaluation and analysis for each detailed structure, which is suitable for the type and length of essay, need to be performed.

For example, an argument, that is, one type of an essay, is developed in the form of an introduction, body, and conclusion structure. It is assumed that there is an argument having a form in which a problem is raised in the introduction, a reason for an assertion is developed in the body, and the assertion is then summarized in the conclusion. An actual professional evaluator will evaluate a corresponding essay while structurally analyzing whether paragraphs have been organically written based on the assertion and reason by considering a structure and development method of such an argument.

Likewise, even in the case of an expository writing, a professional evaluator may evaluate a corresponding essay by considering whether a target to be described in the introduction or a central thought to be spoken has been written or whether the description of a central thought is being developed in the body. In the case of the expository writing or the argument consisting of several paragraphs as described above, a system for automatically evaluating an essay also needs to structurally learn whether paragraphs have been organically constructed and to provide feedback for an insufficient paragraph by performing more detailed evaluation, like an actual professional evaluator.

If the length of an essay is short, structural analysis of a sentence unit not structural analysis of a paragraph unit is required. For example, in the analysis of life writing having a small quantity, which has been described based on a subject “the most memorable incident”, it may be effective in understanding general development to approach the incident in the sentence unit, determine the sequence of events that have happened on the basis of a conjunction, and analyze the incident based on the sequence of the events.

A construction and flow of the entire essay need to be understood through an analysis method that is suitable for the type and length of the essay as described above.

Furthermore, if the entire essay is structurally divided, items, such as grammar adequacy and subject suitability for a divided sentence or a paragraph unit, may be additionally evaluated. Accordingly, in order to increase the accuracy of evaluation of various types of essay in one system and provide a learner with more detailed feedback, there is a need for a technique for a system for automatically evaluating an essay, which is capable of structural analysis.

### SUMMARY

Various embodiments are directed to a system and method for automatically evaluating an essay, which can analyze a structure of an essay or a relation between units through structural modeling suitable for the type and length of the essay, can synthetically evaluate a plurality of evaluation items based on the results of the analysis, and can provide feedback for each detailed structure unit, in order to improve the writing ability of a learner.

Objects of the present disclosure are not limited to the aforementioned object, and other objects not described above may be evidently understood by those skilled in the art from the following description.

In an embodiment, a system for automatically evaluating an essay for writing learning includes a structure analysis module configured to divide learning data and learner essay text in a predetermined structure analysis unit, generate structure tagging information for each structure analysis unit, and structure the learning data and the learner essay text by attaching the structure tagging information to the learning data and the learner essay text, a learning module configured to generate an essay evaluation model through learning by using essay text that is included in the structured learning data and the structure tagging information as an input value and using an evaluation score that is included in the structured learning data as a label, and an evaluation module configured to generate essay evaluation results by inputting, to the essay evaluation model, essay text that is included in the structured learner essay text and the structure tagging information.

In an embodiment, the structure analysis module may include an essay feature extraction unit configured to extract major features of the learning data based on the learning data and extract major features of the learner essay text based on the learner essay text, an essay type and structure unit determination unit configured to determine an essay type and structure analysis unit of the learning data based on the major features of the learning data and determine an essay type and structure analysis unit of the learner essay text based on the major features of the learner essay text, and a structure tagging unit configured to generate structure tagging information for each structure analysis unit of the learning data based on the essay type and structure analysis unit of the learning data and generate structure tagging information for each structure analysis unit of the learner essay text based on the essay type and structure analysis unit of the learner essay text.

In an embodiment, the major features of the learning data may include at least any one of the number of words, number of sentences, number of verbs, lexical features, and discourse marker information of the essay text that is included in the learning data, or a combination of them.

In an embodiment, the major features of the learner essay text may include at least any one of the number of words, number of sentences, number of verbs, lexical features, and discourse marker information of the essay text that is included in the learner essay text, or a combination of them.

In an embodiment, the essay type and structure unit determination unit may determine the essay type of the learning data by using an essay type classification model based on the major features of the learning data. In this case, the essay type classification model may include any one of a support vector machine (SVM), a decision tree, a recurrent neural network (RNN), and a convolutional neural network (CNN).

In an embodiment, the structure tagging unit may generate the structure tagging information for each structure analysis unit of the learning data and the structure tagging information for each structure analysis unit of the learner essay text by using a structure tagging model. In this case, the structure tagging model may be implemented by using a sequential tagging-based methodology.

In an embodiment, the structure tagging information that is generated by the structure tagging unit with respect to the learning data and the learner essay text may include at least any one of names of paragraph level components and names of sentence level components or a combination of them.

In an embodiment, the essay evaluation model may include a structure unit level encoder configured to receive essay text for each structure unit and the structure tagging information and generate an embedding vector for each structure unit, a document level encoder configured to receive all of the generated embedding vectors for each structure unit and generate a document embedding vector, and an output layer configured to receive the document embedding vector and calculate a score for each structure unit and a holistic score of the entire essay.

In an embodiment, the output layer may include a regression model. In this case, the learning module may convert an evaluation score that is included in the structured learning data into a value between 0 and 1 and generates the essay evaluation model through learning by using the converted evaluation score as a label.

In an embodiment, the predetermined structure analysis unit may be any one of a paragraph unit and a sentence unit or a combination of them.

In an embodiment, a method of automatically evaluating an essay for writing learning includes a learner essay text structuring step of dividing learner essay text in a predetermined structure analysis unit, generating structure tagging information for each structure analysis unit, and structuring the learner essay text by attaching the structure tagging information to the learner essay text, an essay evaluation step of generating essay evaluation results by inputting the structured learner essay text to a pre-trained essay evaluation model, and an evaluation result output step of outputting the essay evaluation results.

In an embodiment, the learner essay text structuring step may include steps of extracting major features of the learner essay text based on the learner essay text, determining an essay type and structure analysis unit of the learner essay text based on the major features of the learner essay text, and dividing the learner essay text for each structure analysis unit based on the essay type and structure analysis unit of the learner essay text and generating structure tagging information for each structure analysis unit.

In an embodiment, the major features of the learner essay text may include at least any one of the number of words, number of sentences, number of verbs, and lexical features of essay text that is included in the learner essay text, and discourse marker information or a combination of them.

In an embodiment, the step of determining the essay type and structure analysis unit of the learner essay text may include determining the essay type of the learner essay text by using an essay type classification model based on the major features of the learner essay text and determining the structure analysis unit of the learner essay text based on the major features and the essay type. In this case, the essay type classification model may include any one of a support vector machine (SVM), a decision tree, a recurrent neural network (RNN), and a convolutional neural network (CNN).

In an embodiment, the structure tagging information may include at least any one of names of paragraph level components and names of sentence level components or a combination of them.

In an embodiment, the essay evaluation model may include a structure unit level encoder configured to receive essay text for each structure unit and the structure tagging information and generate an embedding vector for each structure unit, a document level encoder configured to receive all of the generated embedding vectors for each structure unit and generate a document embedding vector, and an output layer configured to receive the document embedding vector and calculate a score for each structure unit and a holistic score of the entire essay.

In an embodiment, the predetermined structure analysis unit may be any one of a paragraph unit and a sentence unit or a combination of them. Furthermore, the essay evaluation results may include a score for each predetermined structure analysis unit of the learner essay text and a holistic score of the entire essay.

In an embodiment, a method of training an essay evaluation model includes a learning data structuring step of dividing essay text that is included in learning data in a predetermined structure analysis unit, generating structure tagging information for each structure analysis unit, and structuring the learning data by attaching the structure tagging information to the essay text, and a step of generating an essay evaluation model through learning by using the essay text that has been divided in the predetermined structure analysis unit and the structure tagging information as an input value and using an evaluation score that is included in the structured learning data as a label.

In an embodiment, the learning data structuring step may include extracting major features of the essay text that is included in the learning data, determining an essay type and structure analysis unit of the essay text that is included in the learning data based on the major features, and dividing the essay text that is included in the learning data for each structure analysis unit based on the essay type and the structure analysis unit and generating the structure tagging information for each structure analysis unit.

In an embodiment, the predetermined structure analysis unit may be any one of a paragraph unit and a sentence unit or a combination of them.

The present disclosure can increase the accuracy of essay evaluation by using structural modeling according to various essay types, and support a learner so that the learner can efficiently improve his or her writing ability because the learner can be provided with detailed evaluation and feedback for each structure unit not simple feedback having one holistic score form.

Furthermore, the present disclosure can provide multilateral evaluation and feedback because tasks, such as subject suitability evaluation or grammar corrections, can be easily performed on each structure unit of an essay.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a block diagram illustrating a construction of a system for automatically evaluating an essay according to an embodiment of the present disclosure.

FIG. 2 is an exemplary diagram of a RNN-based essay type classification model.

FIGS. 3A to 3C are exemplary diagrams of the results of structural analysis by the system for automatically evaluating an essay according to an embodiment of the present disclosure.

FIGS. 4A to 4C are exemplary diagrams of an essay evaluation model.

FIG. 5 is an exemplary diagram of the results of essay evaluation by the system for automatically evaluating an essay according to an embodiment of the present disclosure.

FIG. 6 is a flowchart for describing a method of automatically evaluating an essay according to an embodiment of the present disclosure.

FIG. 7 is a block diagram illustrating a computer system for implementing a method according to an embodiment of the present disclosure.

### DETAILED DESCRIPTION

The present disclosure relates to a system and method for automatically evaluating an essay for writing learning, and synthetically evaluates items, such as content delivery, grammatical accuracy, and representation suitability of an essay of a learner and provides feedback, based on a structure or paragraph construction of the essay by structurally modeling the essay with respect to various essay subjects. The present disclosure selects a proper structure unit by considering the type and length of an essay and then provides feedback for improving the writing ability of a learner by performing structural analysis and evaluation in the selected structure unit, without applying the same structure unit to all types of essay.

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims. Terms used in this specification are used to describe embodiments and are not intended to limit the present disclosure. In this specification, an expression of the singular number also includes an expression of the plural number unless clearly defined otherwise in the context. The term “comprises” and/or “comprising” used in this specification does not exclude the presence or addition of one or more other components, steps, operations and/or elements in addition to mentioned components, steps, operations and/or elements.

In this specification, a “structure analysis unit” and a “structure unit” are used as the same meaning.

In describing the present disclosure, a detailed description of a related known technology will be omitted if it is deemed to make the subject matter of the present disclosure unnecessarily vague.

Hereinafter, embodiments of the present disclosure are described in detail with reference to the accompanying drawings. In describing the present disclosure, in order to facilitate general understanding of the present disclosure, the same reference numeral is used for the same means regardless of the reference numeral.

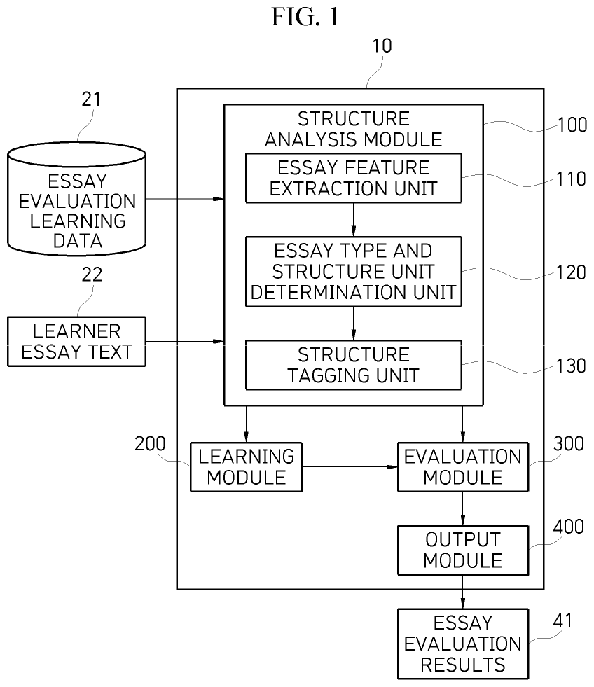

FIG. 1 is a block diagram illustrating a construction of a system for automatically evaluating an essay for writing learning (hereinafter abbreviated as an “essay evaluation system”) according to an embodiment of the present disclosure. This specification has been described assuming that a language used in writing learning is English, but the present disclosure may be applied to all languages which may be represented in text.

An essay evaluation system 10 according to an embodiment of the present disclosure includes a structure analysis module 100, a learning module 200, an evaluation module 300, and an output module 400.

The structure analysis module 100 divides essay evaluation learning data 21 and learner essay text 22 in a predetermined structure analysis unit, generates structure tagging information for each structure analysis unit, and structures the essay evaluation learning data 21 and the learner essay text 22 by attaching the structure tagging information to the essay evaluation learning data and the learner essay text.

The learning module 200 generates an essay evaluation model through learning by using, as an input value, essay text that is included in structured learning data 21′ and the structure tagging information and, as a label, an evaluation score that is included in the structured learning data 21′.

The evaluation module 300 generates essay evaluation results by inputting essay text that is included in structured learner essay text 22′ and the structure tagging information to the essay evaluation model that has been generated by the learning module 200.

The output module 400 outputs the essay evaluation results that have been generated by the evaluation module 300. That is, the output module 400 provides the essay evaluation results to a user of the essay evaluation system 10.

The essay evaluation system 10 of FIG. 1 separately operates in a learning mode and an execution mode. In the learning mode, the structure analysis module 100 and the learning module 200 operate. In the execution mode, the structure analysis module 100, the evaluation module 300, and the output module 400 operate.

In the learning mode of the essay evaluation system 10, the essay evaluation learning data 21 is input to the structure analysis module 100. In the execution mode of the essay evaluation system 10, the learner essay text 22 is input to the structure analysis module 100.

When the essay evaluation system 10 is in the learning mode, the structure analysis module 100 structures the essay evaluation learning data 21 (hereinafter abbreviated as “learning data”), and delivers the structured learning data 21′ to the learning module 200.

When the essay evaluation system 10 is in the execution mode (may also be called an “evaluation mode”), the structure analysis module 100 structures the learner essay text 22 (hereinafter abbreviated as “essay text”) that is received from the outside, and transfers the structured essay text 22′ to the evaluation module 300. The essay text 22 may include a subject sentence. The subject sentence is applied to a process of evaluating, by the evaluation module 300, the subject suitability of the structured essay text 22′ by using a subject suitability determination model. Hereinafter, the learning data 21 and the essay text 22 are commonly called the essay data 21 and 22. The structure analysis module 100 receives the learning data 21 and the essay text 22 from an external database (DB) or a DB that is embedded in the essay evaluation system 10.

In the present disclosure, “structuring” means a task for dividing the essay data 21 and 22 having a text form, such as the learning data 21 or the essay text 22, in a unit such as a paragraph or a sentence, classifying paragraphs or sentences, and structurally tagging the paragraphs or sentences. A “structurally tagging task” refers to a task for generating structure tagging information for a specific paragraph, sentence, or phrase that is included in text and attaching the structure tagging information to a location or range of a corresponding paragraph, sentence, or phrase in the text. The structure tagging information may include information on a location/range in text to which a label is applied, along with the label (i.e., the names of paragraph level components or the names of sentence level components). The names of the paragraph level components may include “Introduction”, “Body”, and “Conclusion”, for example.

A subject sentence that is included in the essay text 22 may also be structured. However, in structuring, a task, such as determining a structure analysis unit, may be omitted from the subject sentence.

The learning module 200 generates the essay evaluation model and a grammar correction model through machine learning based on the structured learning data 21′, and delivers the essay evaluation model and the grammar correction model to the evaluation module 300.

The evaluation module 300 performs essay evaluation on the structured essay text 22′ by using the essay evaluation model that has been generated by the learning module 200. Additionally, the evaluation module 300 may generate a corrected sentence with respect to a sentence that includes a spelling or grammatical error in the structured essay text 22′ by using the grammar correction model that has been generated by the learning module 200. The evaluation module 300 delivers, to the output module 400, essay evaluation results 41 and/or a sentence for which a spelling or grammatical error has been corrected. Furthermore, the evaluation module 300 may generate suitability evaluation results by using the subject suitability determination model based on the structured essay text 22′ and the subject sentence, and may deliver the suitability evaluation results to the output module 400.

The output module 400 outputs the essay evaluation results 41 for the entire essay and for each structure unit. When receiving the corrected sentence, the output module 400 also outputs an error and correction contents by including the error and correction contents in the structured essay text 22′, along with the essay evaluation results 41. The essay evaluation results 41 may further include spelling/grammar correction results and subject suitability evaluation results, in addition to an evaluation score for the essay text. Specifically, the output module 400 may output essay evaluation results (e.g., a score for each structure unit and a holistic score of the entire essay), spelling/grammar correction results (e.g., an error, correction results, and a grammar evaluation score), and subject suitability evaluation results (e.g., a suitability evaluation score for each structure unit and a total suitability evaluation score), along with the structured essay text 22′.

Hereinafter, the structure analysis module 100 of the essay evaluation system 10 according to an embodiment of the present disclosure is described in detail. The structure analysis module 100 includes an essay feature extraction unit 110, an essay type and structure unit determination unit 120, and a structure tagging unit 130.

The essay feature extraction unit 110 extracts major features of the essay data 21 and 22 from the essay data 21 and 22. The major features of the essay data 21 and 22 are used for the essay type and structure unit determination unit 120 to determine the type and structure analysis unit of an essay.

The major features of the essay data 21 and 22 may include information, such as the number of words, number of sentences, number of verbs, lexical features (e.g., major verbs, major verb phrases, major nouns, and major noun phrases), and discourse marker information of the entire essay. The discourse marker refers to a word or phrase that plays an important role in the flow and structure of a discourse. The discourse marker information may further include information on the location and function of a discourse marker in text along with the discourse marker. The essay feature extraction unit 110 may generate discourse marker information by using a discourse annotation tool. Furthermore, the essay evaluation model may use the discourse marker information as structure tagging information of the essay data 21 and 22.

The essay type and structure unit determination unit 120 determines an essay type of the essay data 21 and 22 by using an essay type classification model, based on the essay data 21 and 22 and at least any one of major features of the essay data 21 and 22 or a combination of them. A model, such as a support vector machine (SVM), a decision tree, a recurrent neural network (RNN) based on a neural network, or a convolutional neural network (CNN), may be used as the essay type classification model. The essay type and structure unit determination unit 120 may check whether essay type information has been specified in the essay data 21 and 22, and may determine the essay type of the essay data 21 and 22 only if the essay type information has not been specified.

After determining the essay type of the essay data 21 and 22, the essay type and structure unit determination unit 120 selects a structure analysis unit suitable for the essay type. The essay type and structure unit determination unit 120 selects the structure analysis unit (e.g., a paragraph or a sentence) suitable for the essay evaluation model according to a predetermined criterion, based on the essay type and the major features.

For example, if the essay type that has been determined by the essay type and structure unit determination unit 120 is an argument, the number of words of the essay data 21 and 22 is 150 or more, and the number of paragraphs of the essay data 21 and 22 is 2 or more, the essay type and structure unit determination unit 120 selects a “paragraph” as a structure analysis unit suitable for the essay evaluation model.

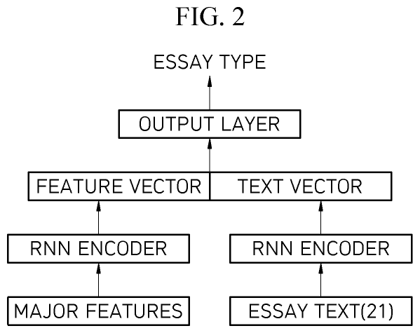

FIG. 2 is an exemplary diagram of a RNN-based essay type classification model. As described above, the essay type classification model that is used by the essay type and structure unit determination unit 120 may have various forms. The RNN-based essay type classification model is only an example. As illustrated in FIG. 2, the essay type and structure unit determination unit 120 may derive the essay type of the essay data 21 and 22 by inputting the essay data 21 and 22 and the major features of the essay data 21 and 22 to the RNN-based essay type classification model. The RNN-based essay type classification model may be constructed to include an RNN encoder and an output layer. The RNN-based essay type classification model is a model that has been pre-trained by using text and major features of the text as an input value and an essay type of the text as a label. The essay type and structure unit determination unit 120 generates a feature vector by inputting the major features of the essay data 21 and 22 to the RNN encoder, and generates a text vector by inputting the essay data 21 and 22 to the RNN encoder. The essay type and structure unit determination unit 120 may obtain the essay type by inputting the feature vector and the text vector to the output layer. The output layer may be implemented in various ways, such as a neural network or a regression model.

The structure tagging unit 130 performs structure tagging on all of the essay data 21 and 22 on the basis of the essay type and the structure analysis unit. Table 1 illustrates components according to an essay type. The structure tagging unit 130 performs tagging for each paragraph or tagging for each sentence by using a structure tagging model by using components as a label. That is, the structure tagging unit 130 generates structure tagging information for the essay data 21 and 22 by using the structure tagging model on the basis of the essay type and the structure analysis unit. The structure tagging information may include a label (e.g., the names of paragraph level components or the names of sentence level components) and a location or a range within the essay data 21 and 22 to which the label will be attached.

As another example, the structure tagging unit 130 may perform both structure tagging for each paragraph and structure tagging for each sentence on all of the essay data 21 and 22 on the basis of only the essay type. For example, if the essay type is an “argument”, the structure tagging unit 130 may assign labels of “Introduction”, “Body”, and “Conclusion” for each paragraph, and may assign labels of “Thesis”, “Major claim”, “Claim”, and “Premise” for each sentence.

TABLE 1

| | | | | SENTENCE LEVEL COMPONENTS | | | |
|---|---|---|---|---|---|---|---|
| EXPOSITORY | PARAGRAPH LEVEL COMPONENTS | | | Topic/ | Major | Minor | |
| WRITING | Introduction | Body | Conclusion | Thesis | support | support | Closing |
| ARGUMENT | Introduction | Body | Conclusion | Thesis | Major claim | Claim | Premise |
| DIARY | Introduction | Body | Conclusion | Topic | Support/Event | | |

The structure tagging model may be implemented by using a sequential tagging-based methodology, such as a long short-term memory with conditional random field (LSTM-CRF). The structure tagging unit 130 determines a label which will be tagged on a paragraph or sentence by using the structure tagging model. The structure tagging unit 130 may select one of paragraph level components as a label to be tagged on each paragraph, and may select one of sentence level components as a label to be tagged on each sentence. For example, if the essay type of the essay data 21 and 22 is an “argument”, the structure tagging unit 130 classifies each paragraph as one of “Introduction”, “Body”, “Conclusion”, “Others”, classifies each sentence as one of “Thesis”, “Major Claim, “Claim”, “Premise”, and “Others”, and performs structure tagging on all of the essay data 21 and 22 based on the results of the classification. The evaluation module 300 uses, as an input to the essay evaluation model, the structure tagging information that has been generated by the structure tagging unit 130.

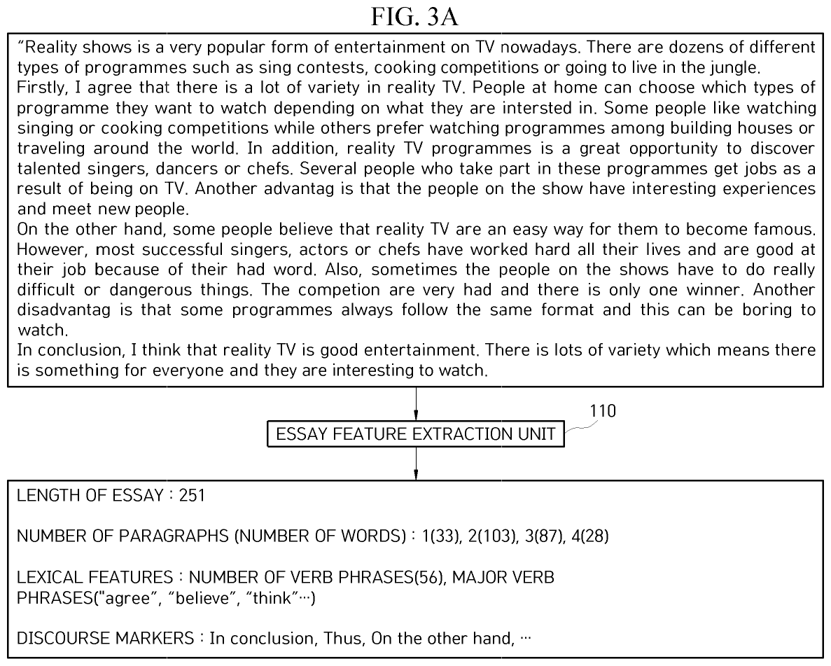

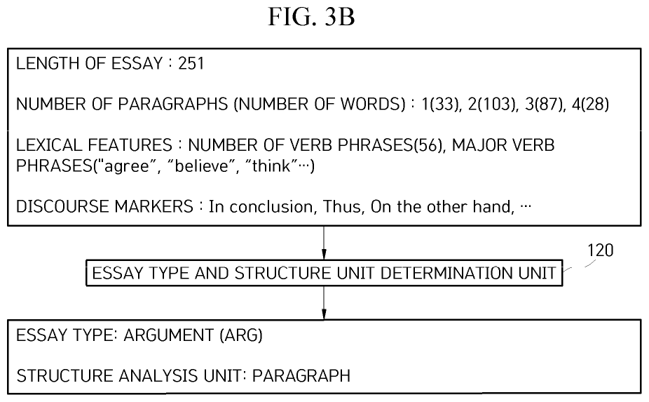

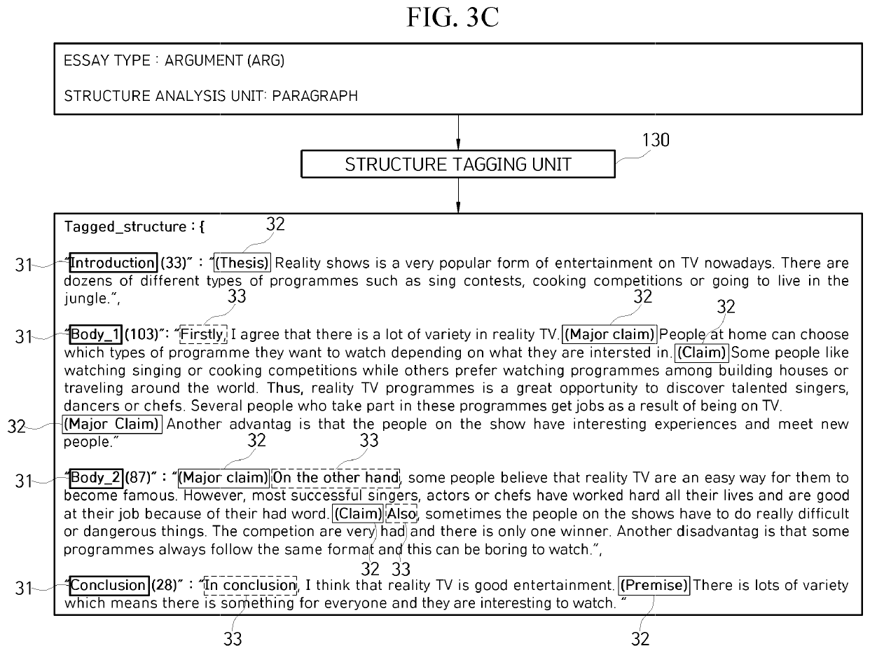

FIGS. 3A to 3C are exemplary diagrams of the results of structural analysis by the system for automatically evaluating an essay according to an embodiment of the present disclosure. Specifically, FIGS. 3A to 3C are examples of the results of execution by the structure analysis module 100. FIG. 3A is an example of the results of execution by the essay feature extraction unit 110. FIG. 3B is an example of the results of execution by the essay type and structure unit determination unit 120. FIG. 3C is an example of the results of execution by the structure tagging unit 130.

In the embodiment of FIG. 3A, the essay feature extraction unit 110 generates major features of the essay data 21 and 22, such as the length, number of paragraphs, number of words, lexical features, and discourse markers of the essay data 21 and 22, based on the essay data 21 and 22. In this process, the essay feature extraction unit 110 may use a lexicon DB that includes words, noun phrases, verb phrase, and discourse markers.

In the embodiment of FIG. 3B, the essay type and structure unit determination unit 120 obtains results in which an essay type of the essay data 21 and 22 is an argument, by inputting the major features (i.e., the length, number of paragraphs, number of words, lexical features, and discourse markers of the essay) of the essay data 21 and 22 to an essay type classification model. Furthermore, the essay type and structure unit determination unit 120 has determined that a structure analysis unit suitable for the essay evaluation model is a “paragraph” because the essay type is an argument, the number of paragraphs in the major features of the essay data 21 and 22 is 2 or more, and the number of words in the major features of the essay data 21 and 22 is 150 or more.

In the embodiment of FIG. 3C, the structure tagging unit 130 has performed structure tagging on the essay data 21 and 22 by using the structure tagging model on the basis of the essay type (“argument”) of the essay data 21 and 22. In the embodiment of FIG. 3C, the structure tagging unit 130 has performed both structure tagging for each paragraph and structure tagging for each sentence on the essay data 21 and 22 by using the structure tagging model on the basis of only the essay type, without being limited to a structure analysis unit.

As illustrated in Table 1, the paragraph level components of the argument include “Introduction”, “Body”, and “Conclusion”. Accordingly, the structure tagging unit 130 performs structure tagging for each paragraph on the essay data 21 and 22 by using a paragraph level component 31 as a label.

Furthermore, since the sentence level components of the argument are “Thesis”, “Major claim”, “Claim”, and “Premise” in Table 1, the structure tagging unit 130 performs structure tagging for each sentence on the essay data 21 and 22 by using a sentence level component 32 as a label.

Additionally, the structure tagging unit 130 may search the essay data 21 and 22 for a discourse marker 33 on the basis of the lexicon DB, and may perform tagging.

Hereinafter, the learning data 21 and the learning module 200 are described. The learning module 200 generates the essay evaluation model and the grammar correction model through learning based on the structured learning data 21′, and delivers the generated essay evaluation model and grammar correction model to the evaluation module 300.

The learning data 21 is essay evaluation data that has been scored by two or more actual experts, with respect to an essay of a learner, which has been written by grade, with respect to various subjects. The learning data 21 includes scoring results (scores) of evaluation elements, such as contents, a construction, representations, and spelling, with respect to the entire essay and for each structure unit. The essay of the learner that is included in the learning data 21 has been labeled with a score for each structure unit (e.g., paragraph) and a holistic score of the entire essay. In this case, the score for each structure unit includes an individual score, total score, and average of each evaluator with respect to items, such as contents, a construction, representations, and spelling. As described above, the structure analysis module 100 generates the structured learning data 21′ based on the learning data 21. The learning module 200 may convert each score (i.e., an individual score, a total score, an average, and a holistic score of the entire essay) of the structured learning data 21′ into a value between 0 and 1 ([0,1]). In this case, a case in which the output layer of the essay evaluation model calculates the score by using a regression model has been considered.

The learning module 200 inputs, to a learning model, the essay text included in the structured learning data 21′, and generates the essay evaluation model by training the learning model so that a score that is calculated by the output layer of the learning model is similar to a holistic score of the entire essay and a score for each structure unit.

Furthermore, the learning module 200 may divide the structured learning data 21′ into training data and test data, may generate the essay evaluation model based on the training data, may derive an optimal parameter and weight of the essay evaluation model based on the test data, and may store the optimal parameter and weight in an internal repository thereof. In this case, the essay evaluation model into which the optimal parameter and weight derived by the learning module 200 has been incorporated is used in the evaluation module 300.

If a sentence including a grammar/spelling error (hereinafter an “erroneous sentence”) is included in the learning data 21, a corrected sentence for the sentence including the error (hereafter a “corrected sentence”) may be further included in the learning data 21. In this case, the erroneous sentence and the corrected sentence are also included in the structured learning data 21′. The learning module 200 generates the grammar correction model through machine learning based on the erroneous sentence (or a paragraph including the erroneous sentence) and the corrected sentence (or a paragraph including the corrected sentence) that are included in the structured learning data 21′. The learning module 200 delivers the grammar correction model to the evaluation module 300. The evaluation module 300 uses the grammar correction model for spelling and grammar feedback.

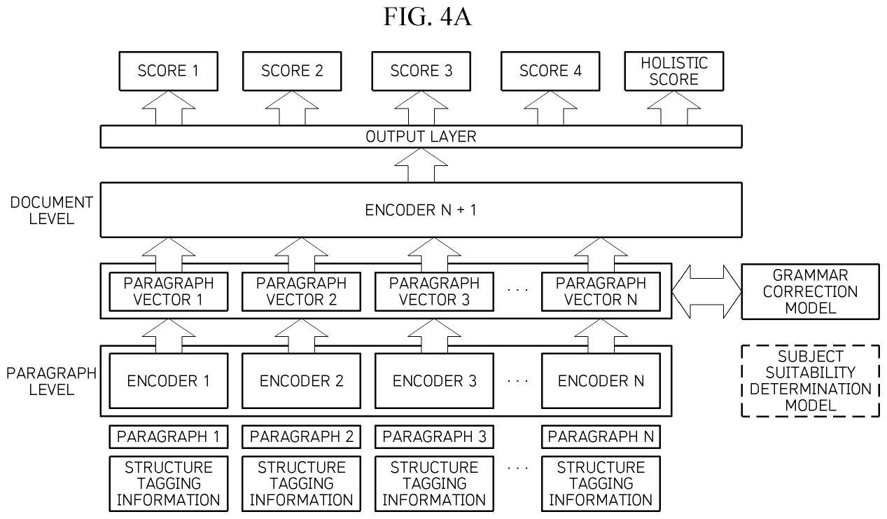

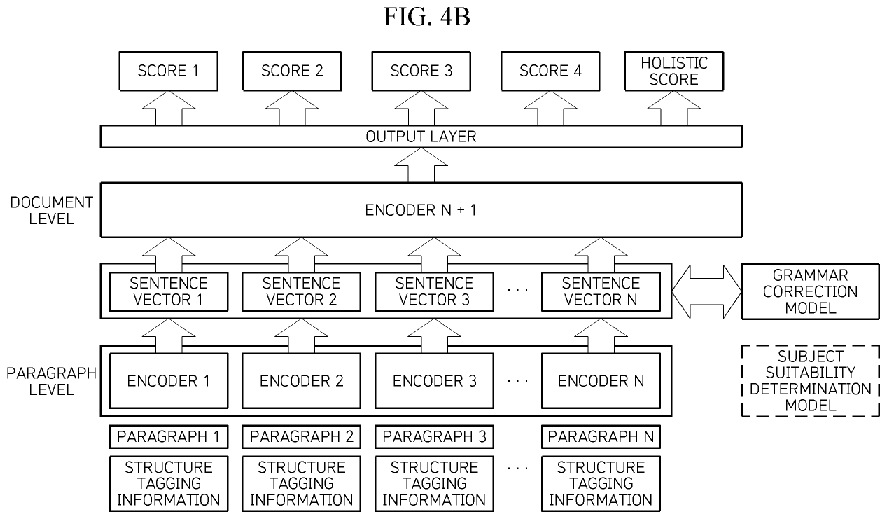

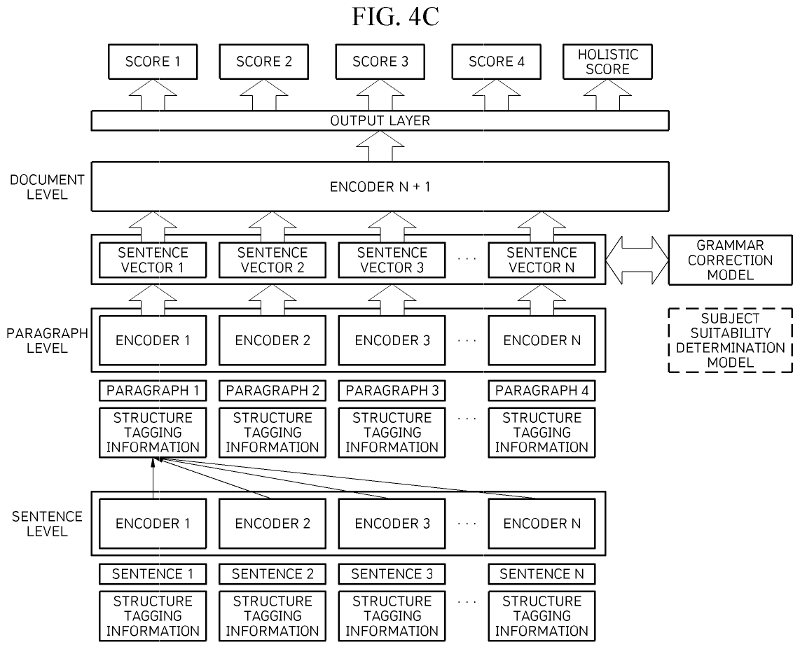

FIGS. 4A to 4C are exemplary diagrams of an essay evaluation model that is generated by the learning module 200 through learning. The essay evaluation model illustrated in FIGS. 4A to 4C is generated by the learning module 200 through learning based on the structured learning data 21′, and is used by the evaluation module 300 when the evaluation module 300 evaluates the essay text 22. The learning module 200 generates the essay evaluation model and delivers the essay evaluation model to the evaluation module 300. Thereafter, when the structured essay text 22′ is input to the evaluation module 300, the evaluation module 300 generates a structure unit embedding vector (e.g., a paragraph vector or a sentence vector) by inputting structure unit text and structure tagging information to a structure unit level encoder (e.g., a paragraph level encoder or a sentence level encoder) of the essay evaluation model, and calculates a score for each structure unit and a holistic score of the entire essay by inputting the structure unit embedding vector to a document level encoder of the essay evaluation model and inputting a product (a document embedding vector) of the document level encoder to an output layer of the essay evaluation model. For reference, the “structure unit level encoder” and the “structure analysis unit level encoder” are used as the same meaning.

As described above, the structure analysis module 100 may determine the structure analysis unit based on the essay type and major features of the essay data 21 and 22, and performs structure tagging for each paragraph and/or for each sentence on the essay data 21 and 22 based on only the essay type or the essay type and the structure analysis unit. Accordingly, the structure analysis module 100 may generate at least any one of structure tagging information for each paragraph and structure tagging information for each sentence or information on a combination of them, with respect to the essay data 21 and 22. The essay evaluation model may be different depending on a structure analysis unit or structure tagging information. For example, if the structure analysis unit is a “sentence” and the structure tagging information has been assigned in a sentence unit, the learning module 200 and the evaluation module 300 performs learning and evaluation by using the structure of an essay evaluation model illustrated in FIG. 4B.

FIG. 4A is an exemplary diagram of the essay evaluation model that has been generated on the basis of a “paragraph” unit, that is, a structure analysis unit that has been determined by the structure analysis module 100. The paragraph level encoder that is included in the essay evaluation model converts text information and structure tagging information of each paragraph into vector representation (or feature representation) with respect to essay text that has been divided for each paragraph. That is, the paragraph level encoder generates a paragraph vector, based on the essay text divided for each paragraph and the structure tagging information. If sentence unit structure information and discourse marker information are included in a corresponding paragraph, the learning module 200 may generate a paragraph vector by inputting, to the paragraph level encoder, the structure tagging information, including tagging information for each paragraph, tagging information for each sentence, and discourse marker information, and the essay text for each paragraph. Thereafter, the learning module 200 inputs the paragraph vector to the document level encoder (N+1) so that the document level encoder learns a structure between the paragraphs. For example, the paragraph level encoder or the document level encoder may be implemented by using any one of a transformer-series encoder model, an LSTM, and an RNN model, such as Bert. However, a method of implementing the paragraph level encoder or the document level encoder is not limited. The output layer of the essay evaluation model may include a regression model. The output layer may receive a product of the document level encoder, and may calculate a holistic score of the entire essay and an evaluation score of each paragraph for each evaluation item in a range between 0 and 1 ([0,1]).

The essay evaluation model of FIG. 4B basically has the same structure as the essay evaluation model of FIG. 4A. However, in the embodiment of FIG. 4B, the paragraph level encoder in FIG. 4A has been substituted with the sentence level encoder. That is, the essay evaluation model according to the embodiment of FIG. 4B is an essay evaluation model that has been generated by the learning module 200 through the execution of learning on the basis of a “sentence” unit. The sentence level encoder in FIG. 4B receives each sentence and structure tagging information, and generates a vector representation (or a sentence vector). Furthermore, the document level encoder learns a structure between sentences that constitute a document. The output layer receives a product of the document level encoder, and calculates a holistic score of the entire essay and an evaluation score of each sentence. Even in this case, each evaluation score may have a range between 0 and 1 ([0,1]).

FIG. 4C is an exemplary diagram of an essay evaluation model that has been generated by complexly learning the structures of sentence and paragraph units. The essay evaluation model of FIG. 4C has a structure in which the essay evaluation models of FIGS. 4A and 4B have been hierarchically stacked. The learning module 200 generates the essay evaluation model by structurally training a basic model in a sentence structure unit, a paragraph structure unit, and a sentence-paragraph structure unit depending on a construction of the basic model. The evaluation module 300 may calculate an evaluation score of a corresponding structure unit by using the essay evaluation model generated as described above.

As illustrated in FIGS. 4A to 4C, the evaluation module 300 may expand an evaluation item by additionally using the grammar correction model and the subject suitability determination model along with the essay evaluation model.

As described above, the learning module 200 generates the grammar correction model through machine learning based on an erroneous sentence (or a paragraph including the erroneous sentence) and a corrected sentence (or a paragraph including the corrected sentence) that are included in the structured learning data 21′. In this case, the learning module 200 may perform the training of the grammar correction model by using an embedding vector of the erroneous sentence (or an erroneous paragraph) as an input of the grammar correction model and using an embedding vector of the corrected sentence (or a corrected paragraph) as a label of the grammar correction model. The learning module 200 may generate the embedding vector of the erroneous sentence (or the erroneous paragraph) or the corrected sentence (or the corrected paragraph) by using the paragraph level encoder or the sentence level encoder that is included in the essay evaluation model, which is illustrated in FIGS. 4A to 4C.

The evaluation module 300 determines a spelling/grammatical error by inputting, to the pre-trained grammar correction model, a vector embedded for each structure unit like a paragraph vector or sentence vector that is generated by using the encoder based on the structured essay text 22′ and comparing the vector with a vector that is output by the grammar correction model. When an error is included in the spelling/grammar, the evaluation module 300 may generate a corrected paragraph or a corrected sentence for the structured essay text 22′ based on the structured learning data 21′. In this case, the evaluation module 300 delivers the corrected paragraph or the corrected sentence to the output module 400. Furthermore, the evaluation module 300 may calculate a grammar evaluation score of the entire essay based on the number of generated corrected sentences. If the structured learning data 21′ has been divided in a paragraph unit, the evaluation module 300 may calculate a grammar evaluation score for each paragraph. The evaluation module 300 delivers an erroneous paragraph (or an erroneous sentence), a corrected paragraph (or a corrected sentence), and a grammar evaluation score for the entire essay and for each structure unit to the output module 400.

The subject suitability determination model is a model to which a similarity-based methodology has been applied, instead of a learning-based method. The evaluation module 300 may evaluate suitability between the structured essay text 22′ and a subject sentence by using the subject suitability determination model. In this case, the “subject sentence” means a sentence or paragraph in which the subject of an essay has been revealed, like “explain about ˜.” or “argue the pros and cons of ˜.” An example of the similarity-based methodology which may be used in the subject suitability determination model may include cosine similarity and a Euclidean distance. The present disclosure does not limit, to the example, the similarity-based methodology which may be used in the subject suitability determination model. The evaluation module 300 may evaluate suitability between a paragraph vector or sentence vector that is generated by inputting the structured essay text 22′ to the encoder of the essay evaluation model and an embedding vector (or a subject sentence embedding vector) that is generated by inputting the subject sentence to the encoder of the essay evaluation model by using the similarity-based methodology, and may deliver the results of the evaluation to the output module 400.

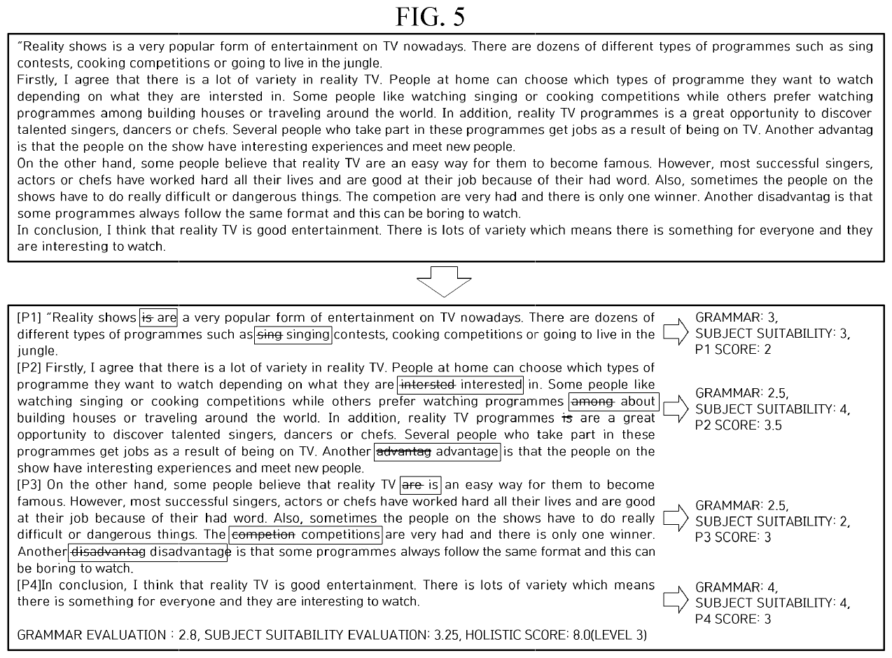

FIG. 5 is an exemplary diagram of the results of essay evaluation by the system for automatically evaluating an essay according to an embodiment of the present disclosure.

FIG. 5 is an example of the results of essay evaluation, which have been output by the output module 400.

The output module 400 outputs essay evaluation results (e.g., a score for each structure unit and a holistic score of the entire essay), spelling/grammar correction results (e.g., an error, correction results, and a grammar evaluation score), and subject suitability evaluation results (e.g., a suitability evaluation score for each structure unit and a total suitability evaluation score) along with the structured essay text 22′.

In the embodiment illustrated in FIG. 5, structural analysis and evaluation have been performed in a paragraph structure unit. As a result, feedback that is provided to a learner includes grammar for the entire essay and for each paragraph, subject suitability, and a holistic score of the entire essay. The output module 400 also provides a corrected sentence with respect to a sentence having a grammatical error for spelling and grammar feedback.

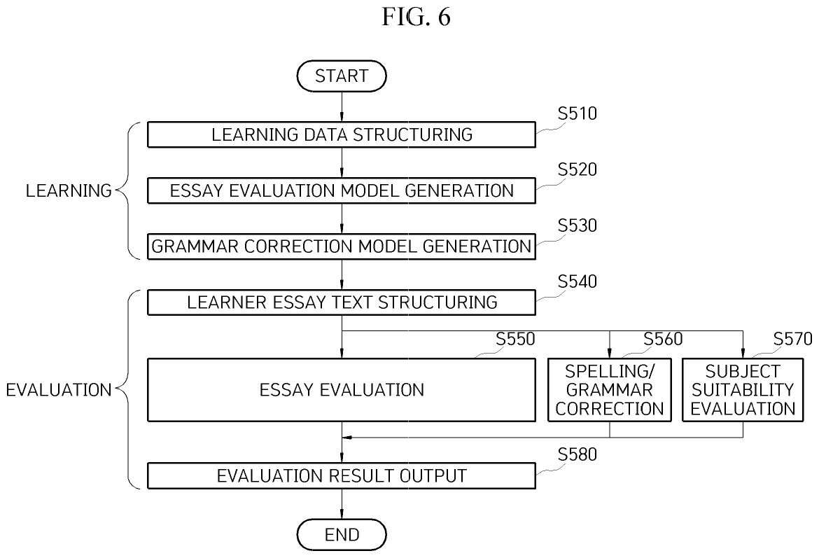

FIG. 6 is a flowchart for describing a method of automatically evaluating an essay according to an embodiment of the present disclosure.

The method of automatically evaluating an essay according to an embodiment of the present disclosure includes steps S510 to S580. However, the steps of the method of automatically evaluating an essay according to the present disclosure are not limited to the embodiment illustrated in FIG. 6. Each of the steps illustrated in FIG. 6 may be divided into detailed steps or may be changed or deleted, if necessary. Furthermore, another step may be added to the step illustrated in FIG. 6. For example, if the essay evaluation model and the grammar correction model have been secured, steps S510 to S530 may be omitted from the method of automatically evaluating an essay.

Steps S510 to S530 are portions relating to learning. In step S510 to S530, the essay evaluation model and the grammar correction model are generated. Steps S540 to S580 are portions relating to evaluation. In steps S540 to S580, essay text of a learner is evaluated by using the essay evaluation model and the grammar correction model, and the results of the evaluation are output.

Steps S510 to S530 may independently construct a method of training the essay evaluation model.

Step S510 is a learning data structuring step.

When receiving the learning data 21, the structure analysis module 100 generates the structured learning data 21′ by structuring the learning data 21. Step S510 may be divided into a major feature extraction step, an essay type determination step, a structure analysis unit determination step, and a structure tagging step. First, the structure analysis module 100 extracts major features from the learning data 21. The major features may include information, such as the number of words, number of sentences, number of verbs, lexical features (e.g., major verbs, major verb phrases, major nouns, and major noun phrases), and discourse marker information of the entire essay. Next, the structure analysis module 100 determines an essay type of the learning data 21 that has been input by using an essay type classification model, based on the learning data 21 and at least any one of the major features or a combination of them. Next, the structure analysis module 100 determines a structure analysis unit (e.g., a paragraph or a sentence) suitable for the essay evaluation model according to a predetermined criterion based on the essay type and the major features. The structure analysis module 100 performs structure tagging on all of the learning data 21 on the basis of the essay type and the structure analysis unit. The structure analysis module 100 delivers the structured learning data 21′ to the learning module 200.

Step S520 is an essay evaluation model generation step.

The learning module 200 inputs, to a learning model, essay text that is included in the structured learning data 21′, and generates the essay evaluation model by training the learning model so that a score that is calculated by the output layer of the learning model is similar to a holistic score of the entire essay and a score for each structure unit. The learning module 200 delivers the essay evaluation model to the evaluation module 300.

Step S530 is a grammar correction model generation step.

The learning module 200 generates the grammar correction model through machine learning based on an erroneous sentence (or a paragraph including the erroneous sentence) and a corrected sentence (or a paragraph including the corrected sentence) that are included in the structured learning data 21′. The learning module 200 delivers the grammar correction model to the evaluation module 300.

Step S540 is a learner essay text structuring step.

When receiving the essay text 22, the structure analysis module 100 generates the structured essay text 22′ by structuring the essay text 22. Step S540 may be subdivided into a major feature extraction step, an essay type determination step, a structure unit determination step, and a structure tagging step. Step S540 has only a different structuring target (the learning data 21 and the essay text 22), and a detailed description thereof is omitted because the contents of a task are the same as those of step S510.

Step S550 is an essay evaluation step.

The evaluation module 300 performs essay evaluation on the structured essay text 22′ by using the essay evaluation model that has been generated in step S520. That is, the evaluation module 300 calculates a score for each structure unit of the structured essay text 22′ and a holistic score of the entire essay. Specifically, the evaluation module 300 generates a structure unit embedding vector (e.g., a paragraph vector or a sentence vector) by inputting structure unit text and structure tagging information to a structure unit level encoder (e.g., a paragraph level encoder or sentence level encoder) of the essay evaluation model, and calculates a score for each structure unit and a holistic score of the entire essay by inputting the structure unit embedding vector to a document level encoder of the essay evaluation model and inputting a product (e.g., a document embedding vector) of the document level encoder to an output layer of the essay evaluation model. The evaluation module 300 delivers essay evaluation results (e.g., a score for each structure unit and a holistic score of the entire essay) to the output module 400. For reference, the “structure unit level encoder” and the “structure analysis unit level encoder” are used as the same meaning.

Step S560 is a spelling/grammar correction step.

The evaluation module 300 performs spelling/grammar corrections on the structured essay text 22′ by using the grammar correction model that has been generated in step S530.

The evaluation module 300 determines a spelling/grammatical error by inputting, to the pre-trained grammar correction model, a vector embedded for each structure unit like a paragraph vector or sentence vector that is generated by using the encoder based on the structured essay text 22′ and comparing the vector with a vector that is output by the grammar correction model. When an error is included in the spelling/grammar, the evaluation module 300 may generate a corrected paragraph or a corrected sentence for the structured essay text 22′ based on the structured learning data 21′. Furthermore, the evaluation module 300 may calculate a grammar evaluation score of the entire essay based on the number of corrected sentences that have been generated. If the structured learning data 21′ has been divided in a paragraph unit, the evaluation module 300 may calculate a grammar evaluation score for each paragraph. The evaluation module 300 delivers an erroneous paragraph (or an erroneous sentence), a corrected paragraph (or a corrected sentence), and the grammar evaluation score for the entire essay and for each structure unit to the output module 400.

Step S570 is a subject suitability evaluation step.

The evaluation module 300 evaluates suitability between the structured essay text 22′ and a subject sentence by using the subject suitability determination model. An example of a similarity-based methodology which may be used in the subject suitability determination model may include cosine similarity and a Euclidean distance. The present disclosure does not limit, to the example, the similarity-based methodology which may be used in the subject suitability determination model. The evaluation module 300 evaluates suitability between a paragraph vector or sentence vector that is generated by inputting the structured essay text 22′ to the encoder of the essay evaluation model and an embedding vector (or a subject sentence embedding vector) that is generated by inputting the subject sentence to the encoder of the essay evaluation model by using the similarity-based methodology, and delivers a suitability evaluation score for each structure unit and a total suitability evaluation score to the output module 400.

Step S580 is an evaluation result output step.

The output module 400 outputs the essay evaluation results 41 that have been received from the evaluation module 300. The essay evaluation results 41 may further include spelling/grammar correction results and subject suitability evaluation results, in addition to the evaluation score of the essay text. Specifically, the output module 400 may output essay evaluation results (e.g., a score for each structure unit and a holistic score of the entire essay), spelling/grammar correction results (e.g., an error, correction results, and a grammar evaluation score), and subject suitability evaluation results (e.g., a suitability evaluation score for each structure unit and a total suitability evaluation score), along with the structured essay text 22′.

The method of automatically evaluating an essay has been described with reference to the flowcharts presented in the drawings. For a simple description, the method has been illustrated and described as a series of blocks, but the present disclosure is not limited to the sequence of the blocks, and some blocks may be performed in a sequence different from that of or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 6, each step may be further divided into additional steps or may be combined into smaller steps depending on an implementation example of the present disclosure. For example, step S510 or S540 may be divided into a major feature extraction step, an essay type determination step, a structure analysis unit determination step, and a structure tagging step. Furthermore, some steps may be omitted, if necessary, and the sequence of steps may be changed. For example, steps S530 and S560 may be omitted, and step S570 may also be omitted. Furthermore, although contents are omitted in the description given with reference to FIG. 6, the contents described with reference to FIGS. 1 to 5 may be applied to the contents described with reference to FIG. 6. Furthermore, the contents described with reference to FIG. 6 may be applied to the contents described with reference to FIGS. 1 to 5.

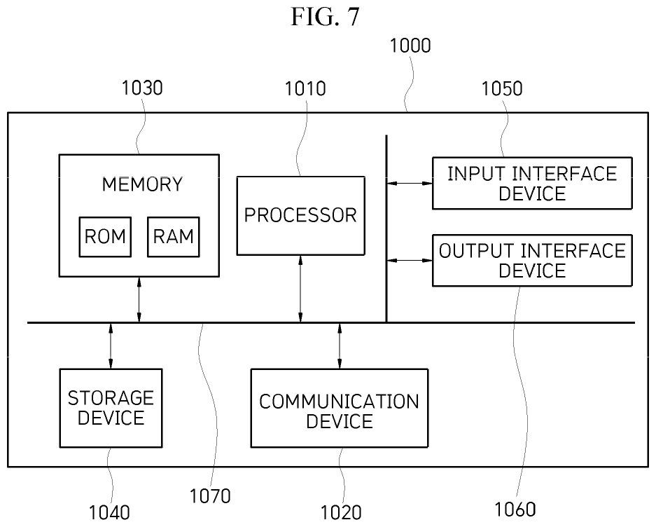

FIG. 7 is a block diagram illustrating a computer system for implementing a method according to an embodiment of the present disclosure.

Referring to FIG. 7, a computer system 1000 may include at least one of a processor 1010, memory 1030, an input interface device 1050, an output interface device 1060, and a storage device 1040 which communicate with one another through a bus 1070. The computer system 1000 may further include a communication device 1020 connected to a network. The processor 1010 may be a central processing unit (CPU) or may be a semiconductor device that executes an instruction stored in the memory 1030 or the storage device 1040. The memory 1030 and the storage device 1040 may include various types of volatile or nonvolatile storage media. For example, the memory may include read only memory (ROM) and random access memory (RAM). In an embodiment of this writing, the memory may be disposed inside or outside the processor, and the memory may be connected to the processor through various means that has already been known. The memory includes various types of volatile or nonvolatile storage media. For example, the memory may include ROM or RAM.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1020 may transmit or receive a wired signal or a wireless signal.

Furthermore, a method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable recording medium may include a hardware device configured to store and execute the program instruction. For example, the computer-readable recording medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

For reference, the components according to an embodiment of the present disclosure may be implemented in the form of software or hardware, such as a digital signal processor (DSP), a field programmable gate array (FPGA) or an application-specific integrated circuit (ASIC), and may perform predetermined roles.

However, the “components” are not meanings limited to software or hardware, and each component may be configured to reside on an addressable storage medium and may be configured to operate one or more processors.

Accordingly, for example, the component may include components, such as software components, object-oriented software components, class components, and task components, processes, functions, attributes, procedures, sub-routines, segments of a program code, drivers, firmware, a microcode, circuitry, data, a database, data structures, tables, arrays, and variables.

Components and functions provided in corresponding components may be combined into fewer components or may be further separated into additional components.

It will be understood that each block of the flowcharts and combinations of the blocks in the flowcharts may be executed by computer program instructions. These computer program instructions may be mounted on the processor of a general purpose computer, a special purpose computer, or other programmable data processing equipment, so that the instructions executed by the processor of the computer or other programmable data processing equipment create means for executing the functions specified in the flowchart block(s). The computer program instructions may also be loaded on a computer or other programmable data processing equipment to cause a series of operational steps to be performed on the computer or other programmable data processing equipment to produce a computer-executed process, so that the instructions executing the computer or other programmable data processing equipment provide steps for executing the functions described in the flowchart block(s).

Furthermore, each block of the flowcharts may represent a portion of a module, a segment, or code, which includes one or more executable instructions for executing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

The term “ . . . unit” or “ . . . module” used in the present embodiment means a software or hardware component, such as an FPGA or an ASIC, and the “ . . . unit” or “ . . . module” performs specific tasks. However, the term “ . . . unit” or “ . . . module” does not mean that it is limited to software or hardware. The “ . . . unit” or “ . . . module” may be configured to reside on an addressable storage medium and configured to operate one or more processors. Accordingly, examples of the “ . . . unit” or “ . . . module” may include components, such as software components, object-oriented software components, class components, and task components, processes, functions, attributes, procedures, sub-routines, segments of a program code, drivers, firmware, a microcode, circuitry, data, a database, data structures, tables, arrays, and variables. The functionalities provided in the components and the “. . . units” or “ . . . modules” may be combined into fewer components and “ . . . units” or “ . . . modules”, or may be further separated into additional components and “ . . . units” or “ . . . modules”. Furthermore, the components and the “ . . . units” or “. . . modules” may be implemented to operate one or more CPUs within a device or a security multimedia card.

Although the present disclosure has been described with reference to the preferred embodiments, those skilled in the art may understand that the present disclosure may be modified and changed in various ways without departing from the spirit and scope of the present disclosure written in the claims.

### DESCRIPTION OF REFERENCE NUMERALS

10: system for automatically evaluating essay
21: essay evaluation learning data
21′: structured learning data
22: learner essay text
22′: structured essay text
31: paragraph level components
32: sentence level components
33: discourse marker
41: essay evaluation results
100: structure analysis module
110: essay feature extraction unit
120: essay type and structure unit determination unit
130: structure tagging unit
200: learning module
300: evaluation module
400: output module

What is claimed is:

1. A system for automatically evaluating an essay for writing learning, comprising:
a structure analysis module configured to divide learning data and learner essay text in a predetermined structure analysis unit, generate structure tagging information for each structure analysis unit, and structure the learning data and the learner essay text by attaching the structure tagging information to the learning data and the learner essay text;
a learning module configured to generate an essay evaluation model through learning by using essay text that is included in the structured learning data and the structure tagging information as an input value and using an evaluation score that is included in the structured learning data as a label; and
an evaluation module configured to generate essay evaluation results by inputting, to the essay evaluation model, essay text that is included in the structured learner essay text and the structure tagging information.

2. The system of claim 1, wherein the structure analysis module comprises:
an essay feature extraction unit configured to extract major features of the learning data based on the learning data and extract major features of the learner essay text based on the learner essay text;
an essay type and structure unit determination unit configured to determine an essay type and structure analysis unit of the learning data based on the major features of the learning data and determine an essay type and structure analysis unit of the learner essay text based on the major features of the learner essay text; and
a structure tagging unit configured to generate structure tagging information for each structure analysis unit of the learning data based on the essay type and structure analysis unit of the learning data and generate structure tagging information for each structure analysis unit of the learner essay text based on the essay type and structure analysis unit of the learner essay text.

3. The system of claim 2, wherein the major features of the learning data comprise at least any one of the number of words, number of sentences, number of verbs, lexical features, and discourse marker information of the essay text that is included in the learning data, or a combination of them.

4. The system of claim 2, wherein the major features of the learner essay text comprise at least any one of the number of words, number of sentences, number of verbs, lexical features, and discourse marker information of the essay text that is included in the learner essay text, or a combination of them.

5. The system of claim 2, wherein:
the essay type and structure unit determination unit determines the essay type of the learning data by using an essay type classification model based on the major features of the learning data, and
the essay type classification model comprises any one of a support vector machine (SVM), a decision tree, a recurrent neural network (RNN), and a convolutional neural network (CNN).

6. The system of claim 2, wherein:
the structure tagging unit generates the structure tagging information for each structure analysis unit of the learning data and the structure tagging information for each structure analysis unit of the learner essay text by using a structure tagging model, and
the structure tagging model is implemented by using a sequential tagging-based methodology.

7. The system of claim 1, wherein the structure tagging information that is generated by the structure tagging unit with respect to the learning data and the learner essay text comprises at least any one of names of paragraph level components and names of sentence level components or a combination of them.

8. The system of claim 1, wherein the essay evaluation model comprises:
a structure unit level encoder configured to receive essay text for each structure unit and the structure tagging information and generate an embedding vector for each structure unit;
a document level encoder configured to receive all of the generated embedding vectors for each structure unit and generate a document embedding vector; and
an output layer configured to receive the document embedding vector and calculate a score for each structure unit and a holistic score of the entire essay.

9. The system of claim 8, wherein:
the output layer comprises a regression model, and
the learning module converts an evaluation score that is included in the structured learning data into a value between 0 and 1 and generates the essay evaluation model through learning by using the converted evaluation score as a label.

10. The system of claim 1, wherein the predetermined structure analysis unit is any one of a paragraph unit and a sentence unit or a combination of them.

11. A method of automatically evaluating an essay for writing learning, comprising:
a learner essay text structuring step of dividing learner essay text in a predetermined structure analysis unit, generating structure tagging information for each structure analysis unit, and structuring the learner essay text by attaching the structure tagging information to the learner essay text;
an essay evaluation step of generating essay evaluation results by inputting the structured learner essay text to a pre-trained essay evaluation model; and
an evaluation result output step of outputting the essay evaluation results.

12. The method of claim 11, wherein the learner essay text structuring step comprises steps of:
extracting major features of the learner essay text based on the learner essay text;
determining an essay type and structure analysis unit of the learner essay text based on the major features of the learner essay text; and
dividing the learner essay text for each structure analysis unit based on the essay type and structure analysis unit of the learner essay text and generating structure tagging information for each structure analysis unit.

13. The method of claim 12, wherein the major features of the learner essay text comprise at least any one of the number of words, number of sentences, number of verbs, lexical features, and discourse marker information of essay text that is included in the learner essay text, or a combination of them.

14. The method of claim 12, wherein:
the step of determining the essay type and structure analysis unit of the learner essay text comprises determining the essay type of the learner essay text by using an essay type classification model based on the major features of the learner essay text and determining the structure analysis unit of the learner essay text based on the major features and the essay type, and
the essay type classification model comprises any one of a support vector machine (SVM), a decision tree, a recurrent neural network (RNN), and a convolutional neural network (CNN).

15. The method of claim 12, wherein the structure tagging information comprises at least any one of names of paragraph level components and names of sentence level components or a combination of them.

16. The method of claim 11, wherein the essay evaluation model comprises:
a structure unit level encoder configured to receive essay text for each structure unit and the structure tagging information and generate an embedding vector for each structure unit;
a document level encoder configured to receive all of the generated embedding vectors for each structure unit and generate a document embedding vector; and
an output layer configured to receive the document embedding vector and calculate a score for each structure unit and a holistic score of the entire essay.

17. The method of claim 11, wherein:
the predetermined structure analysis unit is any one of a paragraph unit and a sentence unit or a combination of them, and
the essay evaluation results comprise a score for each predetermined structure analysis unit of the learner essay text and a holistic score of the entire essay.

18. A method of training an essay evaluation model, comprising:
a learning data structuring step of dividing essay text that is included in learning data in a predetermined structure analysis unit, generating structure tagging information for each structure analysis unit, and structuring the learning data by attaching the structure tagging information to the essay text; and
a step of generating an essay evaluation model through learning by using the essay text that has been divided in the predetermined structure analysis unit and the structure tagging information as an input value and using an evaluation score that is included in the structured learning data as a label.

19. The method of claim 18, wherein the learning data structuring step comprises:
extracting major features of the essay text that is included in the learning data;
determining an essay type and structure analysis unit of the essay text that is included in the learning data based on the major features; and
dividing the essay text that is included in the learning data for each structure analysis unit based on the essay type and the structure analysis unit and generating the structure tagging information for each structure analysis unit.

20. The method of claim 18, wherein the predetermined structure analysis unit is any one of a paragraph unit and a sentence unit or a combination of them.
